(19) United States
(12) Patent Application Publication
(10) Pub. No.: US 2024/0269873 A1
(43) Pub. Date: Aug. 15, 2024

(54) DETERMINING A BEARD GROWTH DISTRIBUTION FOR A SUBJECT

(71) Applicant: KONINKLIJKE PHILIPS N.V., EINDHOVEN (NL)

(72) Inventors: INGRID CHRISTINA MARIA FLINSENBERG, EINDHOVEN (NL); ERIK SCHUIJERS, BREDA (NL)

(21) Appl. No.: 18/571,354

(22) PCT Filed: Jun. 22, 2023
(86) PCT No.: PCT/EP2022/066955

§ 371 Date: Dec. 18, 2023

(30) Foreign Application Priority Data
Jun. 22, 2021 (EP) 21180744.1

(51) Int. Cl. B26B 19/38; B26B 21/40

(52) U.S. Cl. CPC B26B 19/388; B26B 21/4056

(57) ABSTRACT

According to an aspect, there is provided a computer-implemented method for determining a beard growth distribution for a subject. The method comprises receiving (101) movement measurements representing movement of a hair cutting device over a face of the subject during a hair cutting process; determining (103) a set of locations of the hair cutting device during the hair cutting process from the received movement measurements; analysing (105) the set of locations to determine areas of the face in which there is beard growth; and determining (107) the beard growth distribution based on the determined areas of the face in which there is beard growth.

### FIELD OF THE INVENTION

This disclosure relates to analysing a hair cutting process on a face of a subject, and in particular relates to a computer-implemented method, a computer program product and an apparatus for determining a beard growth distribution for the subject from movements of a hair cutting device over the face of the subject during a hair cutting process.

### BACKGROUND OF THE INVENTION

A recent development in the field of hair cutting, and in particular facial hair shaving, are smartphone apps that can be used to monitor the use of a hair cutting device (e.g. an electric shaver), provide advice to the subject on how to achieve better results, and/or provide advice or recommendations to the subject on a particular facial hair style or beard style. A recommendation for a beard style can be based on the category of face shape (e.g. wide, long, average, etc.) and the category of beard growth (e.g. light, average, heavy, etc.) of the subject and perhaps some personal preferences indicated by the subject. These apps can determine the category of face shape and the category of beard growth from a selfie or other image of the subject by means of suitable algorithms. The use of selfies or other images however may result in privacy issues, and is also technically challenging when the quality of the selfie or other image is poor.

Separately, efforts are ongoing to improve the monitoring of a hair cutting device during a hair cutting process to understand the particular movements of the device by the subject. For example, WO 2020/182698 describes how measurements from orientation sensors in a device for performing a treatment operation on a body part can be processed to determine the locations of the device on the body part. WO 2016/113202 describes estimating the position of the head and the position of a device that includes movement sensors such as accelerometers and gyroscopes.

WO 2019/234144 A1 discloses a razor accessory configured to be mechanically attached to a shaving razor to assist a user of the shaving razor. The razor accessory has a camera configured to record an image during a shaving process. The razor accessory is communicatively connected with a control unit configured to process image data from the camera to determine at least one physical characteristic of at least one of a skin surface and a body contour of the user. The razor accessory may further include one or more activity sensors for detecting an activity of the user, for example a sensor to detect motion. Motion data from the sensor may be analyzed by the control unit to provide information about the user's shaving technique, e.g. the number of shaving strokes and the direction and path of the shaving strokes. The user may be notified if the shaving technique is determined to be suboptimal. A picture of the user's face can be shown to the user indicating areas of the face that are sufficiently shaved or that require more shaving.

US 2020/0226660 A1 discloses a digital imaging method of analyzing digital facial images of a user of a razor device for determining a facial shape type of the user and the user's ability to grow hair. A facial hair style is recommended based on the determined facial shape style and the ability to grow hair. The facial shape type of the user and the user's ability to grow hair are determined by comparing, using a neural network, the digital facial images of the user with digital facial images of a plurality of people from a database.

### SUMMARY OF THE INVENTION

Thus, while techniques are available for monitoring the positions or locations of a hair cutting device during a hair cutting process, existing techniques do not provide any information on the distribution of hair (beard) growth on the face of the subject, i.e. existing techniques do not provide information on the areas of the face in which there is beard growth (i.e. the parts of the face in which hair grows), and do not provide information on the density of the hair (beard) growth in those areas. This information can be useful, particularly for evaluating a current beard style of the subject, and for providing a recommendation for a different beard style.

Therefore, there is a need for a technique for determining a beard growth distribution for a subject.

According to a first specific aspect, there is provided a computer-implemented method for determining a beard growth distribution for a subject. The method comprises receiving movement measurements representing movement of a hair cutting device over a face of the subject during a hair cutting process; determining a set of locations of the hair cutting device during the hair cutting process from the received movement measurements; analysing the set of locations to determine areas of the face in which there is beard growth; and determining the beard growth distribution based on the determined areas of the face in which there is beard growth.

In some embodiments, the step of determining the beard growth distribution further comprises determining a respective density of the beard growth in the respective determined areas of the face based on a respective amount of time spent by the hair cutting device in the respective areas of the face. The amount of time spent by the hair cutting device in the respective areas of the face is determined from the set of locations and temporal information in the received movement measurements. Thus, the method can provide information on the areas on which there is beard growth, and the density of that beard growth.

In some embodiments, the method further comprises receiving parameter measurements indicating measurements of one or more parameters relating to the hair cutting process. In these embodiments, the method can comprise analysing the set of locations and the received parameter measurements to determine the areas of the face in which there is beard growth. In these embodiments, the respective density of the beard growth in the respective determined areas of the face can be based on the respective amount of time spent by the hair cutting device in the respective areas of the face and the parameter measurements received when the hair cutting device was at those areas of the face. These embodiments improve the accuracy of the beard growth density information.

In the embodiments where parameter measurements are received, the step of determining the set of locations can comprise determining candidate locations for the hair cutting device during the hair cutting process from the received movement measurements; determining whether the hair cutting device was cutting hair at the candidate locations from the received parameter measurements; and determining the set of locations for the hair cutting device during the hair cutting process by determining a sub-set of the candidate locations at which the hair cutting device was cutting hair. These embodiments improve the estimation of the locations at which there is beard growth by combining information in the movement measurements and in the parameter measurements.

The one or more parameters can comprise any one or more of: a current drawn by a motor in the hair cutting device, a noise or sound produced by the hair cutting device, and a pressure exerted on the face of the subject by the hair cutting device. These parameters are relatively straightforward to measure in a hair cutting device, and provide a useful indication of when the hair cutting device is cutting hair.

In some embodiments, the method further comprises analysing the set of locations to determine a shape of the face of the subject. In these embodiments, the step of analysing the set of locations to determine a shape of the face can comprise determining a face shape class of the subject as one of a plurality of predetermined face shape classes. In these embodiments, the step of analysing the set of locations to determine a shape of the face may comprise, for a plurality of head models corresponding to the plurality of predetermined face shape classes: mapping the set of locations to a mesh of vertices in a head model corresponding to a particular face shape class; determining an error metric representing a difference between the mapped locations and the mesh; and determining, based on the determined error metrics, the face shape class to which the determined shape of the face of the subject corresponds as one of the plurality of predetermined face shape classes. In alternative embodiments, the step of analysing the set of locations to determine a shape of the face can comprise: for a plurality of head models respectively corresponding to the plurality of predetermined face shape classes, comparing one or more metrics of a point cloud corresponding to the set of locations to one or more metrics of respective point clouds corresponding to the head models; and determining, based on the determined metrics, the face shape class to which the shape of the face of the subject corresponds.

In some embodiments, the method further comprises: determining a current beard style class for the subject using the determined areas of the face in which there is beard growth, wherein the current beard style class is determined as one of a plurality of predetermined beard style classes.

In some embodiments, the method further comprises recommending a beard style class for the subject based on the determined beard growth distribution, wherein the recommended beard style class is one of a plurality of predetermined beard style classes.

According to a second aspect, there is provided a computer program product comprising a computer readable medium having computer readable code embodied therein, the computer readable code being configured such that, on execution by a suitable computer or processor, the computer or processor is caused to perform the method according to the first aspect or any embodiment thereof.

According to a third aspect, there is provided an apparatus configured to determine a beard growth distribution for a subject. The apparatus is configured to receive movement measurements representing movement of a hair cutting device over a face of the subject during a hair cutting process; determine a set of locations of the hair cutting device during the hair cutting process from the received movement measurements; analyse the set of locations to determine areas of the face in which there is beard growth; and determine the beard growth distribution based on the determined areas of the face in which there is beard growth.

Embodiments of the apparatus are also contemplated in which the apparatus is further configured to operate according to any of the embodiments of the method according to the first aspect above.

According to a fourth aspect, there is provided a hair cutting system. The hair cutting system comprises: a hair cutting device and an apparatus according to the third aspect or any embodiment thereof.

In some embodiments, the apparatus is part of the hair cutting device. In alternative embodiments, the apparatus is separate from the hair cutting device.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 is an illustration of an exemplary hair cutting device in the form of a rotary shaver;

FIG. 2 is a block diagram of an exemplary hair cutting system comprising a hair cutting device for performing a hair cutting process and an apparatus for determining a beard growth distribution according to this disclosure;

FIG. 3 is a flow chart illustrating an exemplary method according to the disclosure;

FIG. 4 is an illustration of an exemplary set of locations of the hair cutting device during a hair cutting process mapped onto a subject;

FIG. 5 shows an exemplary set of face shape classes; and

FIG. 6 shows an exemplary set of beard style classes.

### DETAILED DESCRIPTION OF THE EMBODIMENTS

As noted above, the techniques described herein enable a beard growth distribution for a subject to be determined from locations of a hair cutting device on the face of the subject during a hair cutting process. During the hair cutting process the hair cutting device is moved over the surface (skin) of the face, and the hair cutting device cuts or shaves the hair at the location of the hair cutting device on the face. During the hair cutting process measurements are obtained representing the movements of the hair cutting device. The device can be a hand-held device, i.e. a device that is to be held in a hand of a user. The user of the hair cutting device may be the person that the hair cutting process is performed on (i.e. the user is using the device on themselves), or the user of the hair cutting device can be using the device to perform the hair cutting process on another person. In both cases, the person that the hair cutting process is performed on is referred to herein as the ‘subject’.

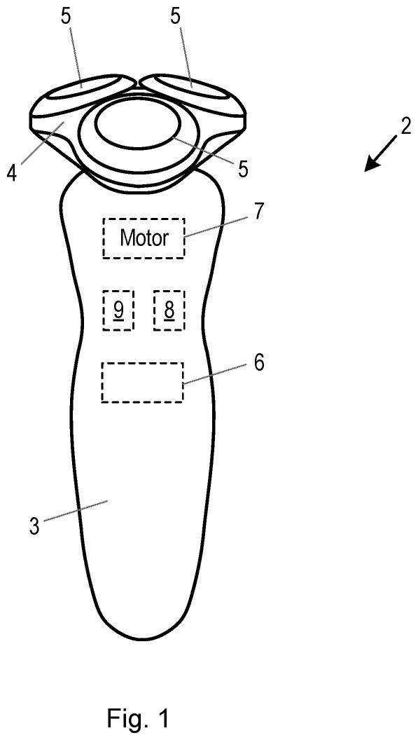

FIG. 1 is an illustration of an exemplary hair cutting device 2 to which the techniques described herein can be applied or used with. In FIG. 1 the hair cutting device 2 is in the form of a rotary shaver, but it will be appreciated that the techniques described herein can be applied to any type of hair cutting device 2, such as an electric shaver, a foil shaver, a beard trimmer, and the Philips OneBlade, etc. The hair cutting device 2 comprises a main body 3 that is to be held in a hand of a user and a cutting head 4 in the form of a shaving portion that includes a plurality of cutting elements 5 for cutting/shaving hair. Each cutting element 5 comprises one or more circular blades or foils (not shown in FIG. 1) that rotate rapidly. When the cutting head 4 is placed on the face and moved hairs on the face are cut by the cutting elements 5. Although the cutting head 4 is shown in FIG. 1 as including three cutting elements 5 arranged in a triangle, it will be appreciated that a rotary shaver 2 can have a different number of cutting elements 5 and/or a different arrangement of cutting elements 5.

Various internal components of the hair cutting device 2 are also shown by dashed boxes in FIG. 1. Thus, FIG. 1 shows the hair cutting device 2 as comprising a movement sensor 6, a motor 7, and two optional sensors 8, 9. The movement sensor 6 is provided to measure the movement of the hair cutting device 2 during the hair cutting process. The motor 7 is provided to generate rotational motion and actuate the cutting elements 5 to cut hair, e.g. by rotating the circular blades or foils. The first optional sensor 8 is a microphone 8 that can be used to measure the sound generated by the motor 7, the cutting head 4, or more generally the hair cutting device 2, during a hair cutting process. The second optional sensor 9 is a pressure sensor 9 that can be used to measure the pressure exerted on the face of the subject with the hair cutting device 2, and more specifically with the cutting head 4, during the hair cutting process.

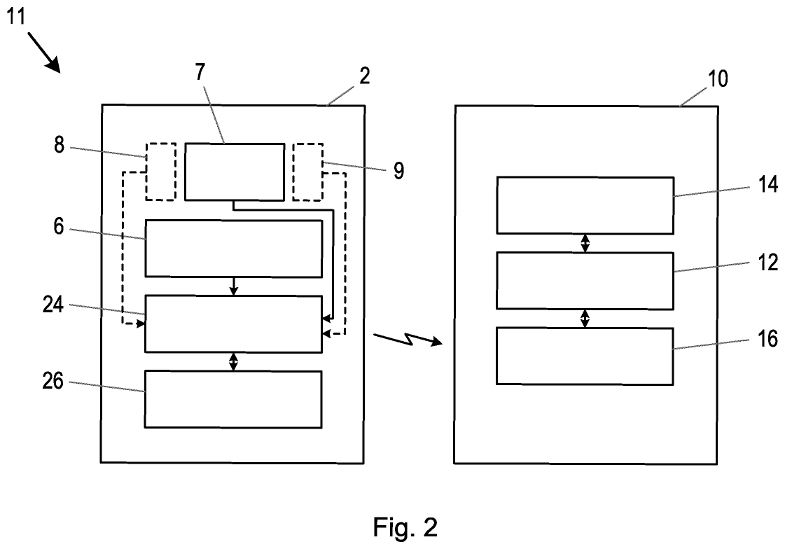

FIG. 2 shows a block diagram of an exemplary apparatus 10 for determining a beard growth distribution for a subject according to the techniques described herein. The apparatus 10 is shown as part of a system 11 that also includes the hair cutting device 2 (e.g. a rotary shaver as shown in FIG. 1). In the embodiments shown in FIG. 2, the apparatus 10 is a separate apparatus to the hair cutting device 2, and thus the apparatus 10 may be in the form of an electronic device, such as a smart phone, smart watch, tablet, personal digital assistant (PDA), laptop, desktop computer, smart mirror, etc. In other embodiments (not shown in FIG. 2), the apparatus 10, and particularly the functionality according to the invention provided by the apparatus 10, is part of the haircutting device 2.

The apparatus 10 comprises a processing unit 12 that generally controls the operation of the apparatus 10 and enables the apparatus 10 to perform the method and techniques described herein. Briefly, the processing unit 12 determines a set of locations of the hair cutting device 2 during a hair cutting process from received movement measurements, analyses the set of locations to determine areas of the face in which there is beard growth, and determines the beard growth distribution based on the determined areas of the face in which there is beard growth.

The processing unit 12 can be configured to receive the movement measurements from another component of the apparatus 10 and therefore the processing unit 12 can include or comprise one or more input ports or other components for receiving the movement measurements from the other component. The processing unit 12 can also include or comprise one or more output ports or other components for communicating with other components of the apparatus 10.

The processing unit 12 can be implemented in numerous ways, with software and/or hardware, to perform the various functions described herein. The processing unit 12 may comprise one or more microprocessors or digital signal processors (DSPs) that may be programmed using software or computer program code to perform the required functions and/or to control components of the processing unit 12 to effect the required functions. The processing unit 12 may be implemented as a combination of dedicated hardware to perform some functions (e.g. amplifiers, pre-amplifiers, analog-to-digital convertors (ADCs) and/or digital-to-analog convertors (DACs)) and a processor (e.g., one or more programmed microprocessors, controllers, DSPs and associated circuitry) to perform other functions. Examples of components that may be employed in various embodiments of the present disclosure include, but are not limited to, conventional microprocessors, DSPs, application specific integrated circuits (ASICs), and field-programmable gate arrays (FPGAs).

The processing unit 12 can comprise or be associated with a memory unit 14. The memory unit 14 can store data, information and/or signals (including movement measurements, any result or any intermediate result of the processing of the movement measurements) for use by the processing unit 12 in controlling the operation of the apparatus 10 and/or in executing or performing the methods described herein. In some implementations the memory unit 14 stores computer-readable code that can be executed by the processing unit 12 so that the processing unit 12 performs one or more functions, including the methods described herein. In particular embodiments, the program code can be in the form of an application for a smart phone, tablet, laptop or computer. The memory unit 14 can comprise any type of non-transitory machine-readable medium, such as cache or system memory including volatile and non-volatile computer memory such as random access memory (RAM), static RAM (SRAM), dynamic RAM (DRAM), read-only memory (ROM), programmable ROM (PROM), erasable PROM (EPROM) and electrically erasable PROM (EEPROM), and the memory unit can be implemented in the form of a memory chip, an optical disk (such as a compact disc (CD), a digital versatile disc (DVD) or a Blu-Ray disc), a hard disk, a tape storage solution, or a solid state device, including a memory stick, a solid state drive (SSD), a memory card, etc.

In the embodiment shown in FIG. 2, as the apparatus 10 is separate from the hair cutting device 2, the apparatus 10 also includes interface circuitry 16 to enable the apparatus 10 to receive the movement measurements from the movement sensor 6 in the hair cutting device 2. The interface circuitry 16 in the apparatus 10 enables a data connection to and/or data exchange with other devices, including any one or more of hair cutting device 2, servers, databases, user devices, and sensors. The connection to the hair cutting device 2 (or any other device) may be direct or indirect (e.g. via the Internet), and thus the interface circuitry 16 can enable a connection between the apparatus 10 and a network, or directly between the apparatus 10 and another device (such as hair cutting device 2), via any desirable wired or wireless communication protocol. For example, the interface circuitry 16 can operate using WiFi, Bluetooth, Zigbee, or any cellular communication protocol (including but not limited to Global System for Mobile Communications (GSM), Universal Mobile Telecommunications System (UNITS), Long Term Evolution (LTE), LTE-Advanced, etc.). In the case of a wireless connection, the interface circuitry 16 (and thus apparatus 10) may include one or more suitable antennas for transmitting/receiving over a transmission medium (e.g. the air). Alternatively, in the case of a wireless connection, the interface circuitry 16 may include means (e.g. a connector or plug) to enable the interface circuitry 16 to be connected to one or more suitable antennas external to the apparatus 10 for transmitting/receiving over a transmission medium (e.g. the air). The interface circuitry 16 is connected to the processing unit 12.

Although not shown in FIG. 2, the apparatus 10 may comprise one or more user interface components that includes one or more components that enables a user of apparatus 10 to input information, data and/or commands into the apparatus 10, and/or enables the apparatus 10 to output information or data to the user of the apparatus 10, for example information indicating the determined beard growth distribution, and in some embodiments, a recommendation for a beard style. The user interface can comprise any suitable input component(s), including but not limited to a keyboard, keypad, one or more buttons, switches or dials, a mouse, a track pad, a touchscreen, a stylus, a camera, a microphone, etc., and the user interface can comprise any suitable output component(s), including but not limited to a display unit or display screen, one or more lights or light elements, one or more loudspeakers, a vibrating element, etc.

It will be appreciated that a practical implementation of an apparatus 10 may include additional components to those shown in FIG. 2. For example, the apparatus 10 may also include a power supply, such as a battery, or components for enabling the apparatus 10 to be connected to a mains power supply.

The hair cutting device 2 shown in FIG. 2 includes the movement sensor 6 for measuring the movements of the hair cutting device 2 during the hair cutting process. The hair cutting device 2 also comprises a device processing unit 24 and interface circuitry 26. The interface circuitry 26 is for transmitting signals from the hair cutting device 2 to the apparatus 10, including transmitting the movement measurements. The interface circuitry 26 can be implemented according to any of the options outlined above for the interface circuitry 16 in the apparatus 10 in order to communicate with the interface circuitry 16 in the apparatus 10.

The movement sensor 6 is integral with or otherwise fixed to the hair cutting device 2 so that the movement sensor 6 directly measures the movement of the hair cutting device 2. The movement sensor 6 can output movement measurements in the form of a continuous signal (or signals) or a time series of measurement samples according to a sampling rate of the movement sensor 6. In some embodiments, the movement sensor 6 is an accelerometer, for example that measures acceleration along three orthogonal axes (i.e. in three dimensions). Alternatively or in addition, the movement sensor 6 can comprise a gyroscope and/or a magnetometer. In some embodiments, multiple types of movement sensor 6 can be part of an inertial measurement unit (IMU). For example, an IMU can comprise an accelerometer, gyroscope and magnetometer.

The device processing unit 24 generally controls the operation of the hair cutting device 2, for example activating and deactivating the motor 7, and thus the cutting elements 5 in the cutting head 4, to effect a hair cutting process. The device processing unit 24 can be implemented in numerous ways according to any of the options outlined above for the processing unit 12 in the apparatus 10.

The device processing unit 24 can be connected to the movement sensor 6 and receives measurements of the movement of the hair cutting device 2 from the movement sensor 6, for example via an input port to the device processing unit 24. In some embodiments, the device processing unit 24 may output the measurements (e.g. raw movement measurements) to the interface circuitry 26 for transmission to the apparatus 10 for subsequent processing. In alternative embodiments, the device processing unit 24 can perform some initial processing on the measurements, for example to reduce noise or other artefacts, and the device processing unit 24 outputs the processed movement measurements to the interface circuitry 26 for transmission to the apparatus 10 for subsequent processing.

In embodiments where the hair cutting device 2 comprises a microphone 8, the device processing unit 24 can be connected to the microphone 8 to receive the measurements of the sound. The microphone 8 is arranged in the hair cutting device 2 to measure the sound generated by the motor 7, the cutting head 4, or more generally the hair cutting device 2, during the hair cutting process. The microphone 8 can output sound measurements in the form of a continuous signal (or signals) or a time series of measurement samples according to a sampling rate of the microphone 8.

In embodiments where the hair cutting device 2 comprises a pressure sensor 9, the device processing unit 24 can be connected to the pressure sensor 9 to receive the measurements of the pressure exerted on the cutting head 4 by the face of the subject (which is equivalent to the pressure exerted on the face of the subject by the cutting head 4). The pressure sensor 9 is arranged in the hair cutting device 2 to measure the pressure exerted. For example, the pressure sensor 9 can be positioned beneath one or more of the cutting elements 5, or between the main body 3 and the cutting head 4. The pressure sensor 9 can output pressure measurements in the form of a continuous signal (or signals) or a time series of measurement samples according to a sampling rate of the pressure sensor 9.

In embodiments where the apparatus 10, or the functionality of the apparatus 10, is part of the hair cutting device 2, the device processing unit 24 can implement the functions of the apparatus processing unit 12 to determine the beard growth distribution of the subject.

It will be appreciated that a practical implementation of hair cutting device 2 may include additional components to those shown in FIG. 2. For example, the hair cutting device 2 may also include a power supply, such as a battery, or components for enabling the hair cutting device 2 to be connected to a mains power supply.

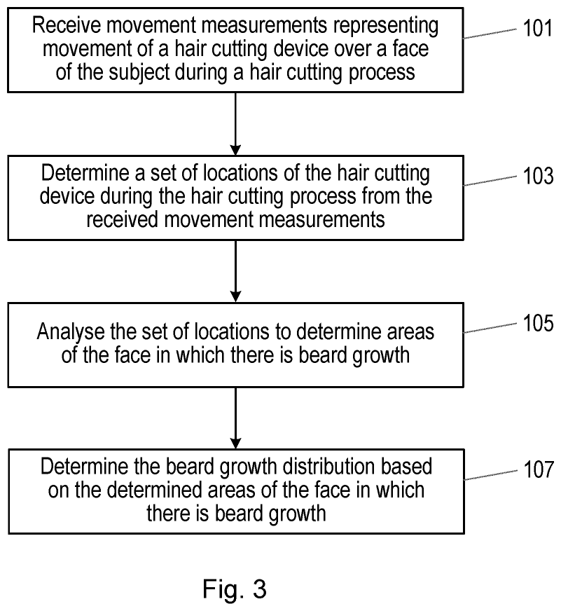

The flow chart in FIG. 3 illustrates an exemplary method performed by the apparatus 10 according to the techniques described herein. One or more of the steps of the method can be performed by the processing unit 12 in the apparatus 10, in conjunction with the interface circuitry 16 (if present) and memory unit 14, as appropriate. The processing unit 12 may perform the one or more steps in response to executing computer program code, that can be stored on a computer readable medium, such as, for example, the memory unit 14.

As noted above, the techniques described herein provide for a set of locations of the hair cutting device 2 during a hair cutting process to be determined from received movement measurements. Thus, in step 101 movement measurements that represent the movement of the hair cutting device 2 over the face of the subject during a hair cutting device 2 are received. The movement measurements can be received from one or more movement sensors 6. In the following it is assumed that the movement sensor 6 is an accelerometer, but other and/or additional types of movement sensor can be used. The set of locations are analysed to determine areas of the face in which there is beard growth, and the beard growth distribution is determined based on the areas of the face in which there is beard growth.

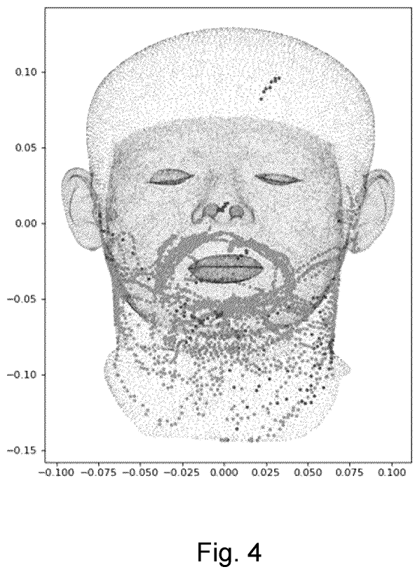

In step 103, the movement measurements from the movement sensor 6 are processed to determine the locations of the hair cutting device 2 during the hair cutting process (e.g. step 103 determines the locations where the user has shaved). In embodiments where the movement sensor 6 is an accelerometer, step 103 can involve double integrating the acceleration measurements with respect to time to determine the locations. Preferably, step 103 is performed once the hair cutting process (e.g. shaving) is complete, so all movement measurements are available for analysis. In particular embodiments, the movement measurements can be used to determine a time sequence of the locations of the hair cutting device 2 during the hair cutting process. These locations can be expressed in Cartesian coordinates (i.e. X, Y, Z coordinates), but other coordinate systems can be used instead. In some embodiments, step 103 can be implemented using the techniques described in WO 2020/182698. FIG. 4 is an illustration of an exemplary set of locations of the hair cutting device 2 during a hair cutting process mapped onto an image of a subject. Each location of the hair cutting device 2 is represented as a dot.

In some embodiments of step 103, the set of locations determined from the movement measurements may have been filtered to remove any locations where the hair cutting device 2 is not cutting hair/shaving. In these embodiments, in step 103 the movement measurements from the movement sensor 6 are processed to determine candidate locations for the hair cutting device 2, and a sub-set of the candidate locations are selected as the set of locations for the hair cutting device 2 during the hair cutting process. For example, the candidate locations may include locations where the hair cutting device 2 is not in contact with the face, e.g. at the start and end of the hair cutting process, and during the hair cutting process if the hair cutting device 2 is repositioned to another part of the face, and so these candidate locations will not be useful for determining the shape of the face of the subject or the areas of the face on which there is beard growth. These candidate locations where no hair cutting or shaving is taking place can be excluded from the set of locations, and so the remaining candidate locations are those locations at which hair cutting or shaving is taking place.

In these embodiments, measurements of one or more parameters relating to the hair cutting process can be analysed to determine if hair cutting was occurring. The one or more parameters can be measured during the hair cutting process and the measurements synchronised with the movement measurements so that the parameter measurements can be used to determine whether hair cutting was occurring at the different candidate locations of the hair cutting device 2. The one or more parameters can comprise any of a current drawn by the motor 7 in the hair cutting device 2, a noise or sound produced by the hair cutting device 2, and a pressure exerted on the face of the subject by the hair cutting device 2.

Measurements of the current drawn by the motor 7 can be output from the motor 7 itself, or measured by the device processing unit 24 in the hair cutting device 2. When hair cutting is occurring, the current drawn by the motor 7 will be higher than when hair is not being cut. Therefore the current drawn by the motor 7 can be compared to a threshold value to determine is hair is being cut. If hair is not being cut at that candidate location, that candidate location is excluded. Measurements of the noise or sound produced by the hair cutting device 2 can be obtained using microphone 8 in the hair cutting device 2. When hair cutting is occurring, the noise or sound produced by the hair cutting device 2, and primarily the motor 7 and cutting element(s) 5, will be different to when hair is not being cut. Therefore measurements of the noise or sound produced by the hair cutting device 2 can be analysed to determine if the noise or sounds correspond to hair being cut. In some embodiments, the analysis of the noise or sound can evaluate an amplitude or maximum amplitude of the measured noise or sound. In addition or alternatively, the analysis of the noise or sound can evaluate the frequency components of the noise or sound. If it is determined that hair is not being cut at a particular candidate location, that candidate location is excluded.

Measurements of the pressure exerted on the face of the subject by the hair cutting device 2 can be obtained using the pressure sensor 9. When hair cutting is occurring, the hair cutting device 2 is pressed against the face of the subject. Therefore, the measured pressure can be analysed to determine whether the hair cutting device 2 is pressed against the face at a particular candidate location. Candidate locations at which the hair cutting device 2 is not pressed against the face can be excluded.

In the example shown in FIG. 4, the lighter coloured dots correspond to candidate locations at which it is determined from pressure measurements that hair cutting or shaving was taking place, and the darker coloured dots correspond to candidate locations at which it is determined from pressure measurements that no hair cutting or shaving was taking place. The darker coloured dots are subsequently excluded from the set of locations.

In some embodiments, the filtering of the candidate locations can also be used to remove outliers from the set of locations, for example due to measurement errors or artefacts. For example, one or more candidate locations may appear to be outliers when compared to the rest of the candidate locations, and these outliers can be excluded. In the example shown in FIG. 4, the group of locations on the forehead can be identified as outliers when compared to the rest of the candidate locations, and this group of locations on the forehead can be excluded. In another example, if a particular candidate location suggests the hair cutting device 2 is following a path that is inconsistent with the shape of a face, that candidate location can be excluded as an outlier. In embodiments where the shape of the face is determined using the techniques described below, these outlier locations can be identified based on a distance between the location and a nearest vertex in a head model being too high (i.e. above a threshold value).

In some embodiments, the set of locations determined in step 103 can be used to determine the shape of the face of the subject. In practice, for a subject with a ‘long face’ shape, the hair cutting device 2 will be moved more in the vertical direction (compared to a subject with a round face), which will result in more vertical accelerations detected by the movement sensor 6. Similarly, for a subject with a wide face the hair cutting device 2 will be moved more in the horizontal direction. As a consequence the locations for a subject with a long face will exhibit a more elongated pattern in the vertical direction, while the locations for a subject with a wide face will exhibit a more elongated pattern in the horizontal direction.

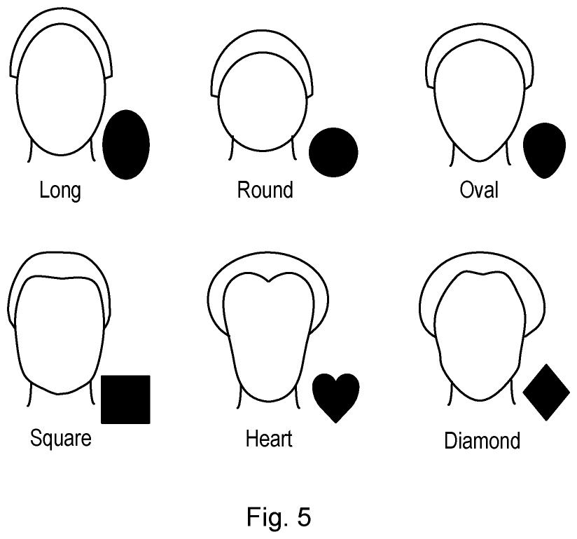

Typically, the face of a subject (or more generally the head of a subject) can be classified into one of a plurality of different face shape classes. FIG. 5 shows an exemplary set of six face shape classes. The face shape classes in FIG. 5 include a long face, round face, oval face, square face, heart face and diamond face. Those skilled in the art will appreciate that other or further face shape classes can be included, or sub-classes defined of one or more of the classes shown in FIG. 5. For example, a tapered square shape, narrow diamond, wide diamond, etc. In addition, although the face shape classes shown in FIG. 5 relate to the shape of the face when viewed from the front, since the hair cutting device 2 is typically also used on the side of the face and on part of the neck, the face shape classes can also differ based on the side profile of the face. For example, for each of the six face shape classes shown in FIG. 5, there can be ‘shallow’, ‘normal’ and ‘long’ sub-classes relating to the depth of the face (e.g. the distance from the back of the jaw to the front). As another example, for each of the six face shape classes shown in FIG. 5, there can be sub-classes for different chin profiles, such as a short chin, long chin, double chin, protruding chin, pointed chin, receding chin, etc.

In a first embodiment for determining face shape, the set of locations is mapped to a typical 3D head model for each face shape class to be distinguished. In particular, for a particular 3D head model formed as a mesh of vertices, each location of the hair cutting device 2 can be mapped or projected to the mesh, and the corresponding distance between the location and mesh computed. For example, the Euclidean distance between the location and the vertices of the head model can be computed, and minimum distance can be selected as the distance to the mesh. Next, an error metric representing the mapping of the locations to the head model is determined. This error metric can be computed based on the distances between the locations and the respective nearest vertices in the head model. For example the error metric can be determined as the average (mean) or median distance between the locations and respective nearest vertex. This mapping and error metric computation can be repeated for head models representing the different face shapes, and the face shape associated with the head model with the smallest error metric can be selected as the face shape of the subject.

In a second embodiment for determining the face shape, a ‘point cloud’ corresponding to the set of locations in a 3D space is compared to a point cloud of the 3D head models representing the different face shapes to identify a head model that is most similar to the locations ‘point cloud’. In particular, one or more metrics of the point cloud can be determined and compared to corresponding metrics for the different head models. The one or more metrics of the point cloud and head model can be, for example, a width of the face represented by the point cloud or model, the length of the face represented by the point cloud or model, a ratio of the width of the face to the length of the face, etc. The head model with metrics that are the most similar to the metrics of the point cloud can be determined to represent the face shape of the subject. In case multiple metrics are used, the metrics can be weighted to determine the most similar head model from the possible head models.

In step 105, the set of locations determined in step 103 is analysed to determine the areas of the face of the subject in which there is beard growth. Typically, areas of the face with no hairs or no hair growth do not need to be shaved, and so those areas of the face will therefore be hardly present in the set of locations of the hair cutting device 2 during the hair cutting process. Areas with a lot of hair growth need more attention from the hair cutting device 2 and will usually be visited more often during a hair cutting process. It should be noted that the areas of the face of the subject in which there is beard growth are areas in which hair grows on the subject. That is, even though following the hair cutting process the face of the subject may now be clean shaven, the areas of beard growth are the areas of the face that the hair cutting device 2 cut hair to produce the clean-shaven result. Likewise, one or more areas of the face of the subject may still have hair following the hair cutting process (for example if the hair in those areas was trimmed rather than fully shaved off), and those areas are also areas of beard growth.

Therefore in embodiments where the set of locations excludes locations where the hair cutting device 2 was not cutting hair, the set of locations of the hair cutting device 2 can be considered to indicate the areas of the face in which there is beard growth.

In embodiments where measurements of one or more parameters are available (and whether or not these measurements are used to filter a set of candidate locations in step 103), these parameter measurements can be analysed to determine when the hair cutting device 2 was cutting hair, and the areas of beard growth can be determined as those locations corresponding to when the parameter measurements indicated that the hair cutting device 2 was cutting hair.

In step 107, a beard growth distribution is determined for the subject based on the areas identified in step 105 as having beard growth. The beard growth distribution is a representation of the face of the subject indicating in which part or parts of the face there is beard growth, i.e. the part of parts of the face on which hair grows.

In some embodiments of step 107, the locations at which it is determined in step 105 that there is hair growth can be mapped to a 3D head model in order to relate those locations to a vertex of the mesh network representing the 3D head model. In embodiments where the shape of the face of the subject is determined, the 3D head model on which the hair growth areas are mapped can be a 3D head model corresponding to the shape of the face of the subject. Alternatively, the 3D head model on which the hair growth areas are mapped can be common or generic head model.

In some embodiments, information on the beard growth distribution can be output to the subject or other user of the hair cutting device 2 or apparatus 10. The information can be output in the form of an image showing the areas of the face in which there is hair growth. The output image can be an image of the subject (e.g. a selfie or other photograph) on which the areas of beard growth are indicated or overlaid. Alternatively the output image can be a generic image of a face or head on which the areas of beard growth are indicated or overlaid.

In some embodiments of step 107, the beard growth distribution can be further based on (i.e. include information relating to) the density of the beard growth in the areas of the face in which there is hair growth. Thus, in addition to the beard growth distribution indicating the areas of the face in which hair grows, the beard growth distribution can indicate the density or thickness of that hair growth. It should be noted that the density of the hair growth primarily refers to the number of hair-growing follicles in a particular area of the face, but the density can also or alternatively relate to the thickness of individual hairs in a particular area.

Thus, some embodiments of step 107 further comprise determining the density of the hair growth in the areas of the face in which there is hair growth. The density of the hair growth can be approximated from the amount of time that the hair cutting device 2 spent cutting hair in that area. That is, areas with low density hair growth will typically require less ‘passes’ of the hair cutting device 2 over the area, and/or less time spent in that area, than areas with high density hair growth. The amount of time that the hair cutting device 2 spent in a particular area can be determined from the set of locations and temporal information associated with the movement measurements. That is, temporal (time) information will be received as part of the movement measurements, and therefore a time can be associated with each of the determined locations of the hair cutting device 2 during the hair cutting process. By evaluating the distribution of the locations of the hair cutting device 2 during the hair cutting process, it will be possible to determine the amount of time (or relative amount of time) the hair cutting device 2 spent in the different areas of the face. As noted, areas of the face in which the hair cutting device 2 spent a relatively longer amount of time can be considered to be areas of higher density hair growth, and areas of the face in which the hair cutting device 2 spent a relatively shorter amount of time can be considered to be areas of lower density hair growth. In a simple embodiment, a measure of the density of hair growth is an area can be given by the time spent in that area divided by the duration of the hair cutting process (i.e. the total shaving time).

In some embodiments, in addition to considering the time spent cutting hair in each area, the density of the hair growth can be determined based on the measurements of the one or more parameters. In areas with high density beard growth, the motor 7 in the hair cutting device 2 will need to work harder than in areas with low density beard growth, and therefore the current drawn by the motor 7 will be higher for areas of higher density hair growth than for areas of lower density hair growth. Therefore, in some embodiments the current drawn by the motor 7 while the hair cutting device 2 is at a particular location can be evaluated and used to provide an indication of the density of beard growth at that location. For example the current drawn by the motor 7 can be compared to one or more threshold values to determine the density of the beard growth at that location.

In further embodiments, the current drawn by the motor 7 can be determined for a first visit to a particular area of the face (with the first visit being determined from temporal information associated with the determined locations), and this current can indicate the density of beard growth in that area before the start of the hair cutting process. When the same area is visited by the hair cutting device 2 multiple times, and the current drawn by the motor 7 remains high, this indicates that the beard growth is high. Alternatively, if the current drawn by the motor 7 is lower or very low on subsequent visits to that area in the same hair cutting process, the subject is most likely not completely satisfied with the cleanness of the shave, but this does not necessarily indicate that this area has high density beard growth. Therefore, to estimate the density of the beard growth, for each time that the hair cutting device 2 is in a particular area x, the visit duration dᵢ and the average motor current during that visit cᵢ are determined. The beard growth density can be estimated from, for example, a weighted average of dᵢ and cᵢ. For example, the weighted average can be given by 1/TCΣcᵢdᵢ, where T the total shave duration and C is the average motor current during the full hair cutting process, although it will be appreciated that other functions of the motor current can be used.

In addition or alternatively, in areas with high density beard growth, the noise or sound produced by the hair cutting device 2 will be different to the noise or sound produced in areas with low density beard growth. Therefore, in some embodiments measurements of the noise or sound generated by the hair cutting device 2 at a particular location, or changes in the noise or sound generated relative to another location, can be evaluated and used to provide an indication of the density of beard growth at that location. For example the measurements of the noise or sound can be compared to one or more threshold values to determine the density of the beard growth at that location.

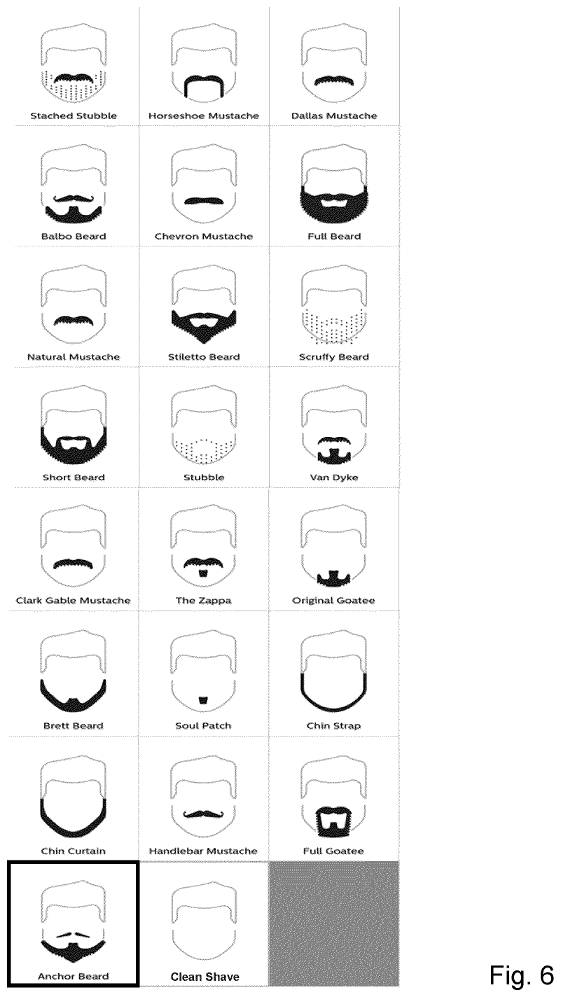

In some embodiments, the method can further comprise determining the current beard style class of the subject based on the beard growth distribution determined in step 107. That is, a number of different beard style classes can be predetermined, and the beard growth distribution used to determine which of the beard style classes the subject has, either before, and/or after, the hair cutting process. FIG. 6 shows an exemplary set of beard style classes from which the subject's current beard style can be determined. Thus, FIG. 6 shows 23 different beard style classes, with various combinations and/or styles of beard and moustache, and a ‘clean shave’ style.

For example, the areas in which there is hair growth as indicated by the beard growth distribution can be compared to the areas of hair growth in each beard style class to determine a closest match, and that beard style class can be selected as the current beard style class of the subject. Alternatively, the user or subject can be presented with the beard style classes via a graphical user interface on the apparatus 10, and the user or subject can manually select the correct beard style class.

In some embodiments, the method can further comprise determining and providing a recommendation of a beard style class for the subject. This recommendation can be determined based on the information in the beard growth distribution about the areas of the face in which hair grows. In some embodiments, the recommended beard style class is determined from the beard style classes for which the subject has the required beard growth. Thus, the pattern of areas in which the subject has hair growth can be matched to the areas of beard growth required for each of the beard style classes.

As an example, if it determined that the subject has little beard growth on their upper lip, but good beard growth elsewhere, the recommended beard style class can be any of the beard style classes that do not require a moustache, for example the ‘chin strap’ beard class style.

In some embodiments, the current beard style class of the subject can be taken into account in determining the recommended beard style class. In particular, the recommended beard style class may be a beard style that can be achieved from the current beard style class of the subject. For example, the current beard style class of the subject might be the ‘Van Dyke’ style class shown in FIG. 6, in which case the recommended beard style class can be selected from the ‘Original Goatee’, the ‘Soul Patch’, the ‘Natural Moustache’ and ‘The Zappa’.

In embodiments where the shape of the face of the subject is determined, the recommended beard style class for the subject can be determined taking into account the shape of the subject's face or the subject's face shape class. For example, certain beard style classes may only be suitable for certain face shape classes/face shapes, in which case the recommended beard style class can be selected from those suitable for the subject's face shape class/face shape.

In some embodiments, the recommendation of the beard style class can take into account one or more preferences of the subject. These preferences can be input via a user interface of the apparatus 10. The preferences could indicate that, for example, the subject does or does not want to have a moustache, or does or does not want areas of stubble.

Therefore there is provided a technique for determining a beard growth distribution for a subject.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computer-implemented method for determining a beard growth distribution for a subject, characterized in that the method comprises:
receiving movement measurements representing movement of a hair cutting device over a face of the subject during a hair cutting process;
determining a set of locations of the hair cutting device during the hair cutting process from the received movement measurements;
analysing the set of locations to determine areas of the face in which there is beard growth; and
determining the beard growth distribution based on the determined areas of the face in which there is beard growth.

2. A method as claimed in claim 1, wherein the step of determining the beard growth distribution further comprises determining a respective density of the beard growth in the respective determined areas of the face based on a respective amount of time spent by the hair cutting device in the respective areas of the face, wherein the amount of time spent by the hair cutting device in the respective areas of the face is determined from the set of locations and temporal information in the received movement measurements.

3. A method as claimed in claim 1, wherein the method further comprises receiving parameter measurements indicating measurements of one or more parameters relating to the hair cutting process.

4. A method as claimed in claim 3, wherein the method comprises analysing the set of locations and the received parameter measurements to determine the areas of the face in which there is beard growth.

5. A method as claimed in claim 3, wherein the respective density of the beard growth in the respective determined areas of the face is based on the respective amount of time spent by the hair cutting device in the respective areas of the face and the parameter measurements received when the hair cutting device was at those areas of the face.

6. A method as claimed in claim 3, wherein the one or more parameters comprise any one or more of: a current drawn by a motor in the hair cutting device, a noise or sound produced by the hair cutting device, and a pressure exerted on the face of the subject by the hair cutting device.

7. A method as claimed in claim 1, wherein the method further comprises:
analysing the set of locations to determine a shape of the face of the subject.

8. A method as claimed in claim 7, wherein the step of analysing the set of locations to determine a shape of the face comprises determining a face shape class of the subject as one of a plurality of predetermined face shape classes.

9. A method as claimed in claim 8, wherein the step of analysing the set of locations to determine a shape of the face comprises, for a plurality of head models corresponding to the plurality of predetermined face shape classes:
mapping the set of locations to a mesh of vertices in a head model corresponding to a particular face shape class;
determining an error metric representing a difference between the mapped locations and the mesh; and
determining, based on the determined error metrics, the face shape class to which the determined shape of the face of the subject corresponds as one of the plurality of predetermined face shape classes.

10. A method as claimed in claim 8, wherein the step of analysing the set of locations to determine a shape of the face comprises:
for a plurality of head models respectively corresponding to the plurality of predetermined face shape classes, comparing one or more metrics of a point cloud corresponding to the set of locations to one or more metrics of respective point clouds corresponding to the head models; and
determining, based on the determined metrics, the face shape class to which the shape of the face of the subject corresponds.

11. A method as claimed in claim 1, wherein the method further comprises:
determining a current beard style class for the subject using the determined areas of the face in which there is beard growth, wherein the current beard style class is determined as one of a plurality of predetermined beard style classes.

12. A method as claimed in claim 1, wherein the method further comprises:
recommending a beard style class for the subject based on the determined beard growth distribution, wherein the recommended beard style class is one of a plurality of predetermined beard style classes.

13. A computer program product comprising a computer readable medium having computer readable code embodied therein, the computer readable code being configured such that, on execution by a suitable computer or processor, the computer or processor is caused to perform the method of claim 1.

14. An apparatus configured to determine a beard growth distribution for a subject, characterized in that the apparatus is configured to:
receive movement measurements representing movement of a hair cutting device over a face of the subject during a hair cutting process;
determine a set of locations of the hair cutting device during the hair cutting process from the received movement measurements;
analyse the set of locations to determine areas of the face in which there is beard growth; and
determine the beard growth distribution based on the determined areas of the face in which there is beard growth.

15. A hair cutting system comprising:
a hair cutting device; and
an apparatus as claimed in claim 14.
